(19) United States
(12) Patent Application Publication
(10) Pub. No.: US 2006/0047862 A1
(43) Pub. Date: Mar. 2, 2006

(54) Automatic hardware data link initialization

(75) Inventors: Robert A. Shearer, Rochester, MN (US); Bruce M. Walk, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: International Business Machines Corporation, Armonk, NY (US)

(21) Appl. No.: 10/932,710

(22) Filed: Sep. 2, 2004

(51) Int. Cl. G06F 3/00

(52) U.S. Cl. 710/15; 713/503

(57) ABSTRACT

Methods and apparatuses that may be utilized to automatically train and activate communications links between two or more devices are provided. In some embodiments, one or more state machines may be used to monitor and control the behavior of receive and transmit logic during the automatic training and activation, thus, reducing or eliminating the need for software intervention. As a result, training and activation may begin with little delay after a power-on cycle.

### BACKGROUND OF THE INVENTION

1. Field of the Invention

The present invention generally relates to exchanging packets of data on a bus between two devices and, more particularly to automatically initializing communications interfaces on both devices.

2. Description of the Related Art

A system on a chip (SOC) generally includes one or more integrated processor cores, some type of embedded memory, such as a cache shared between the processors cores, and peripheral interfaces, such as external bus interfaces, on a single chip to form a complete (or nearly complete) system. The external bus interface is often used to pass data in packets over an external bus between these systems and an external device, such as an external memory controller or graphics processing unit (GPU). To increase system performance, the data transfer rates between such devices has been steadily increasing over the years.

Unfortunately, as the data transfer rate between devices increases, bytes of data transferred between devices may become skewed for different reasons, such as internal capacitance, differences in drivers and/or receivers used on the different devices, different routing of internal bus paths, and the like. Such skew may cause data transferred from one device to be read erroneously by the other device. This misalignment can lead to incorrectly assembled data fed into the processor cores, which may have unpredictable results and possibly catastrophic effects.

One approach to minimize this type of skew is to perform some type of training under software control, whereby internal drivers and/or receivers of one device may be adjusted while the other device outputs specially designed data packets (e.g., having known data patterns). Unfortunately, there may be substantial delay (e.g., after a system power-on cycle) before such software code can be executed. Further, performing such training in software may undesirably delay or interrupt the execution of actual application code. There is also a potential problem that may be caused by the inability to fetch the application code from memory across the link if the link is not trained automatically.

Accordingly, what is needed are methods and apparatus for automatically training and activating communications links between devices, preferably with little or no software intervention.

### SUMMARY OF THE INVENTION

The present invention generally provides methods and apparatus for automatically training and activating communications links between two or more devices.

One embodiment provides a method of training a local device for communication with a remote device over a communications link without software intervention. The method generally includes, under hardware control, (a) transmitting a plurality of first predefined packets from the local device to the remote device over the communications link, (b) monitoring the communications link for one or more first predefined data packets transmitted from the remote device to the local device over the communications link, (c) transmitting a synchronization sequence including a plurality of the first predefined packets followed by a second predefined packet from the local device to the remote device over the communications link, in response to receiving one or more first predefined data packets by the local device from the remote device, and (d) allowing the exchange of packets under software control only after receiving one or more second predefined packets from the remote device indicating the remote device is trained.

Another embodiment provides a method of training two devices for communication over a link. The method generally includes performing initial hardware controlled link training in each device to compensate for skew between bits of data transmitted over the link, performing hardware controlled handshaking between the devices to indicate successful link training, and performing periodic hardware controlled link training in each device to periodically adjust for skew between bits of data transmitted over the link.

Another embodiment provides a self-initializing bus interface for use in communicating between a first device containing the bus interface and a second device over a communications link. The bus interface generally includes a hardware state machine configured to transmit first predetermined packets to the second device during a link training state and transition to an active state in response to detecting second predetermined packets received from the second device, indicating the second device is trained.

Another embodiment provides a system generally including a bus having a plurality of parallel bit lines, a first processing device, and a second processing device coupled with the first processing device via the bus. A self-initializing bus interface on each of the first and second processing devices is generally configured to perform, without software interaction, initial link training to compensate for skew between bits of data transmitted over the link, handshaking with the other device to indicate successful link training, and periodic link training to adjust for skew between bits of data transmitted over the bus.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates an exemplary system including a central processing unit (CPU), in which embodiments of the present invention may be utilized.

FIG. 2 is a block diagram of a communications interface according to one embodiment of the present invention.

FIG. 3 is a state diagram corresponding to a link training state machine, according to one embodiment of the present invention.

FIG. 4 is a flow diagram of exemplary operations for automatic link training, according to one embodiment of the present invention.

FIG. 5 is a diagram of exemplary operations for automatic link training performed at local and remote devices, according to one embodiment of the present invention.

### DETAILED DESCRIPTION OF THE INVENTION

The principles of the present invention provide for methods and apparatuses that may be utilized to automatically train and activate communications links between two or more devices. In some embodiments, one or more state machines may be used to monitor and control the behavior of receive and transmit logic during the automatic training and activation, thus, reducing or eliminating the need for software intervention. As a result, training and activation may begin with little delay after a power-on cycle.

As used herein, the term state machine generally refers to an object in a system that goes through a defined sequence of states in response to various events, with each state often indicated by a specific observable action, such as the generation of a signal. Embodiments of the present invention will be described with reference to state machines implemented as hardware components that respond to various events, typically with the generation of one or more signals used to control the behavior of some other component. However, various behaviors of the state machines may be determined by software-controlled registers, such as registers used to hold adjustable threshold counter values or time-out periods.

Further, in the following description, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and, unless explicitly present, are not considered elements or limitations of the appended claims.

### An Exemplary System

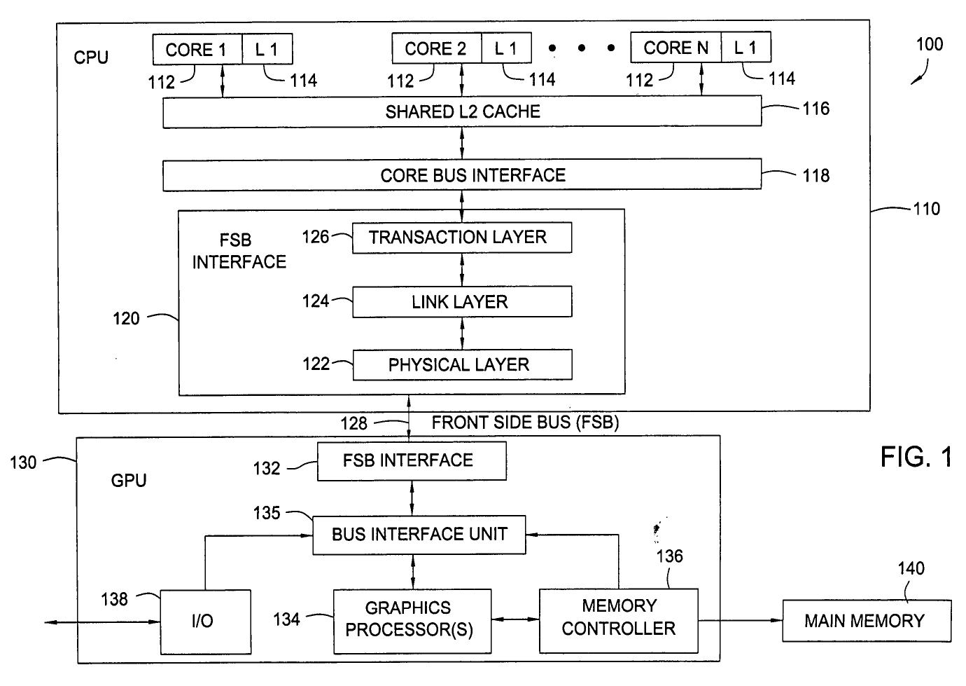

FIG. 1 illustrates an exemplary computer system 100 including a central processing unit (CPU) 110, in which embodiments of the present invention may be utilized. As illustrated, the CPU 110 may include one or more processor cores 112, which may each include any number of different type function units including, but not limited to arithmetic logic units (ALUs), floating point units (FPUs), and single instruction multiple data (SIMD) units. Examples of CPUs utilizing multiple processor cores include the Power PC line of CPUs, available from International Business Machines (IBM).

As illustrated, each processor core 112 may have access to its own primary (L1) cache 114, as well as a larger shared secondary (L2) cache 116. In general, copies of data utilized by the processor cores 112 may be stored locally in the L2 cache 116, preventing or reducing the number of relatively slower accesses to external main memory 140. Similarly, data utilized often by a processor core may be stored in its L1 cache 114, preventing or reducing the number of relatively slower accesses to the L2 cache 116.

The CPU 110 may communicate with external devices, such as a graphics processing unit (GPU) 130 and/or a memory controller 136 via a system or frontside bus (FSB) 128. The CPU 110 may include an FSB interface 120 to pass data between the external devices and the processing cores 112 (through the L2 cache) via the FSB 128. An FSB interface 132 on the GPU 130 may have similar components as the FSB interface 120, configured to exchange data with one or more graphics processors 134, input output (I/O) unit 138, and the memory controller 136 (illustratively shown as integrated with the GPU 130), via a bus interface unit (BIU) 135.

As illustrated, the FSB interface 120 may include a physical layer 122, link layer 124, and transaction layer 126. The physical layer 122 may include hardware components for implementing the hardware protocol necessary for receiving and sending data over the FSB 128. The physical layer 122 may exchange data with the link layer 124 which may format data received from or to be sent to the transaction layer 126. The transaction layer 126 may exchange data with the processor cores 112 via a core bus interface (CBI) 118. For some embodiments, data may be sent over the FSB as packets. Therefore, the link layer 124 may contain circuitry (not shown) configured to encode into packets or “packetize” data received from the transaction layer 126 and to decode packets of data received from the physical layer 122.

### Automatic Link Initialization

As previously described, bytes of data transferred over the FSB 128 between the CPU 110 and GPU 130 (or any other type of high speed interface between devices) may become skewed due to various factors, such as internal capacitance, differences in internal components (e.g., drivers and receivers), different routing of the internal data paths, and the like. In order to compensate for such skew, both devices may utilize some type of mechanism (e.g., the mechanisms may work together) to automatically train and activate the communications links. The architecture described herein may be utilized to achieve and maintain synchronization between both sides of the link (also referred to herein as link training), including a handshaking protocol where each device can indicate to the other it is synchronized.

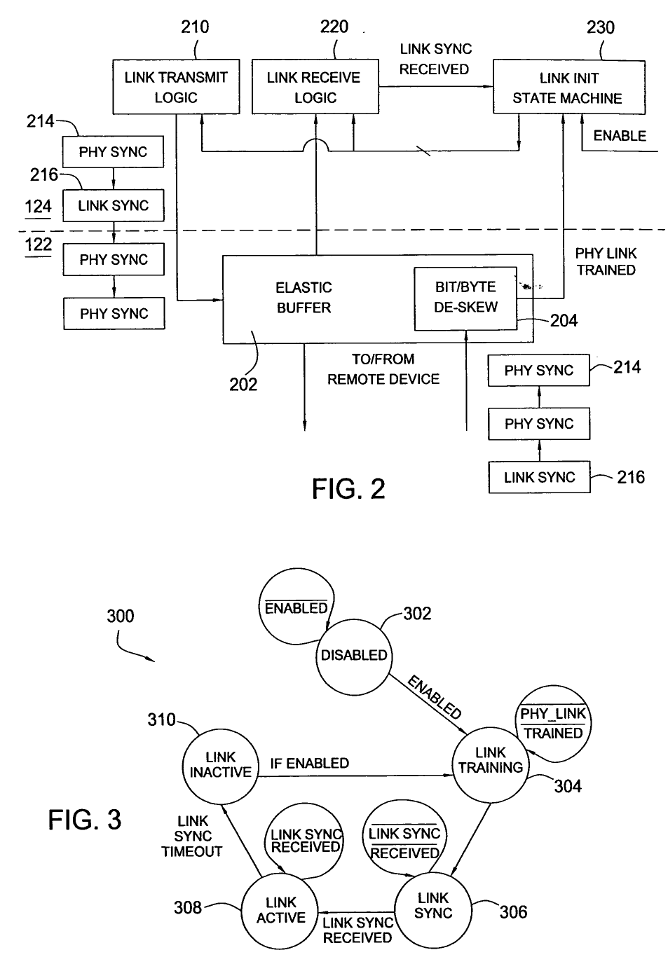

For example, as illustrated in FIG. 2, the link layer 124 may include one or more state machines 230 generally configured to monitor the local physical layer 122, as well as a physical layer of the remote device with which the local device communicating (e.g., a physical layer in the FSB interface 132 of the GPU 130). While only one side of a communications link is shown (the CPU 120 side), it should be understood that similar operations may be performed on the other side of the link (e.g., the GPU 130 side). As illustrated, the state machine 230 may also monitor and control link transmit and receive logic 210 and 220, respectively, in the link layer 124, as well as an elastic buffer 202 used to hold data transferred to and from the link layer 124. In general, the term elastic buffer refers to a buffer that has an adjustable size and/or delay to hold varying amounts of data for varying amounts of time, depending on how rapidly the link layer is able to fill or unload data.

As illustrated, a bit de-skew component 204 may be provided to compensate for skew between bits of data received. Proper bit alignment may be achieved, for example, by multiplexing various time-delayed versions of bit signals to eliminate skew. For some embodiments, the bit de-skew component 204 may automatically adjust each bit to achieve proper alignment while packets of known data, referred to herein as a physical synchronization (Phy-Sync) packets 214 are transmitted by the device at the other end of the link. Physical synchronization may also involves aligning each individual data bit to a clock signal transmitted with the data using analog phase detection circuitry. In other words, signals on individual bit lines may, in effect, be delayed in order to properly align them with one or more bit signals that lag behind them. These adjustments may be made to various bit signals until the resulting bytes match the known patterns transmitted in the Phy-Sync packets. For some embodiments, in one or more states, the state machine 230 may generate one or more signals causing the link transmit logic 210 to transmit a stream of Phy-Sync packets, allowing similar adjustments to the physical layer of the remote device.

### Exemplary Link Initialization States

FIG. 3 is a state diagram 300 illustrating the various states of the state machine 230, in accordance with one embodiment of the present invention. As illustrated, the state machine 230 may begin in a Disabled state 302 until an ENABLED signal is asserted. While not shown, it should be noted that each state shown (Link Training 304, Link Sync 306, Link Active 308, and Link Inactive 310) may also transition directly to the Disabled state if the ENABLED signal is de-asserted. It should also be noted that, for some embodiments, the link may be assumed to be in operation all the time and the Disabled state 302 may be removed. For embodiments with a Disabled state, the FSB interface 120 may remain in this state in the absence of a stable (e.g., debounced for some period of time) power signal or when the ENABLED signal is de-asserted under program control (e.g., via a control register accessible by program code). As illustrated, when enabled, the link may transition from the Disabled state 302 to a Link Training state 304.

In the Link Training state 304, the hardware (drivers and receivers) of the physical layer 122 may be adjusted to match those of the remote device at the other end of the link (e.g., adjusting for proper bit/byte de-skew and clock alignment). Upon entering this state, the link transmit logic 210 begins to transmit a continuous stream of Phy-Sync packets 214, enabling training of the remote device hardware. The link receive logic 220 is also enabled and begins a training process looking for Phy-Sync packets received from the remote device. The physical layer 122 may remain in this state while no Phy-Sync packets 214 are received from the remote device and may transition back to the Disabled state if the ENABLED signal is disabled.

For some embodiments, a transition from the Link Training state 304 to the Link Sync state 306 occurs when the remote device begins transmitting Phy-Sync packets (indicating the remote device has also entered the Link Training state) and when the receiver hardware of the physical link 122 of the local device is successfully trained. For some embodiments, the physical layer hardware may indicate successful training by asserting a PHY_LINK_TRAINED signal, for example, when de-skew logic 204 has been properly adjusted for bit alignment resulting in detection of Phy-Sync packets. Alternatively, link receive logic 220 may determine training has been successful when some predetermined number of Phy-Sync packets have been received and counted.

In the Link Sync state 306, the link transmit logic 210 may transmit a Synchronization sequence (Sync sequence) including some number (M) of Phy-Sync packets followed by a different type of packet having a known data pattern (shown as a Link-Sync packet 216 in FIG. 2). For some embodiments, the Phy-Sync and Link-Sync packets may differ only by some small number of bit values. In any case, the transmission of a Link-Sync packet indicates to the remote device that the local device is trained. Similarly, receipt of a Link-Sync packet from the remote device indicates the remote device is trained. For some embodiments, the link receive logic 220 may indicate receipt of a Link-Sync packet by asserting a LINK_SYNC_RECEIVED signal, causing a transmission to the Link Active state 308.

The Link Active state 308 indicates the physical and link layers 122 and 124 of both sides of the link have performed the necessary handshaking to validate they can transfer information between each other. Thus, in this state, packets may be transferred between the local and remote devices at will. Due to variations in time with drivers, receivers, and wiring caused by environmental factors, the local and remote devices may be at risk of falling out of synch (due to bit skew). Therefore, in order to maintain synchronization and stay in the Link Active state 308, each device on the link may be required to periodically transmit a Sync sequence (M Phy-Sync packets followed by a Link-Sync packet), allowing periodic adjustments of link hardware. For some embodiments, if a periodic Sync sequence is not received within some timeout period (e.g., an adjustable Link Sync timeout period), retraining of the link may be initiated.

For example, if a Sync sequence is not received within the predetermined Link Sync timeout period, a transition to a Link Inactive state may occur. From the Link Inactive sate 310, a transition back to the Link Training state 304 may occur, if the ENABLED signal is still asserted, otherwise a transition back to the Disabled state 302 may occur. The Link Inactive state 310 is optional and may be removed for some embodiments.

### Exemplary Link Training Operations

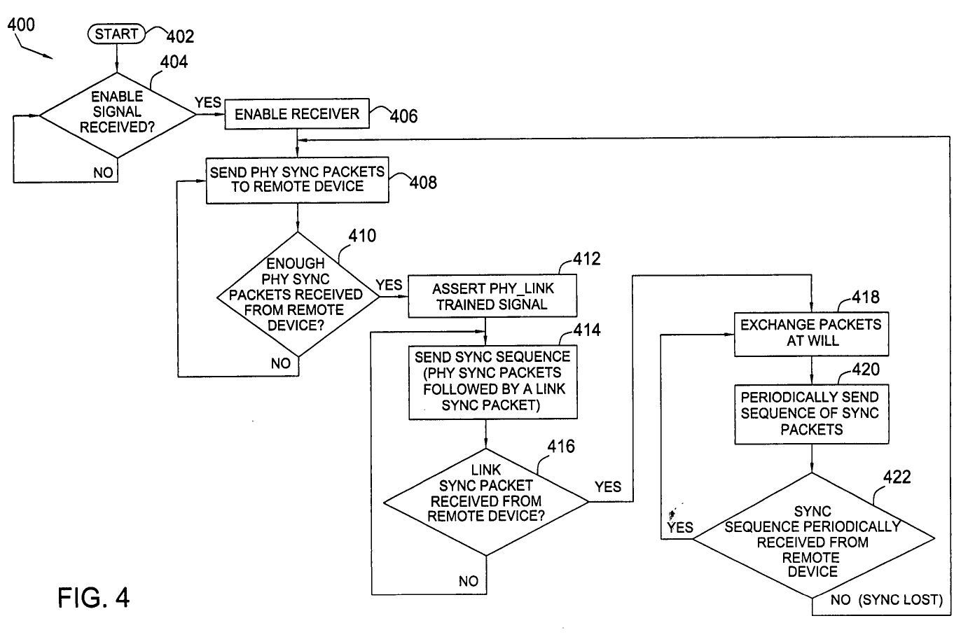

FIG. 4 is a flow diagram illustrating exemplary operations 400 performed at the local device with respect to each state shown in FIG. 3. The operations 400 begin at step 402, for example, upon system power-up, entering the Disabled state 302. The device remains in the Disabled state 302 until the ENABLED signal is asserted, at step 404. Once the ENABLED signal is asserted, the device transitions to the Link Training state 304, and enables the link receive logic, at step 406. At step 408, the link transmit logic 408 begins to send Phy-Sync packets to the remote device.

Once a Phy-Sync packet is received (or the physical link is trained), the PHY_LINK_TRAINED signal may be asserted at step 412, causing a transition to the Link Sync state 306. At step 414, a Sync Sequence (Phy-Sync packets followed by a Link-Sync packet) is transmitted to the remote device, providing an indication the local device is trained. The local device remains in the Link Sync state 306 until a Link-Sync packet is received from the remote device, at step 416, indicating the remote device is also trained. Once the Link-Sync packet is received from the remote device, the local device may transition to the Link Active state 308 and packets may exchanged at will, at step 418. As illustrated, the local device may periodically send Sync Sequences to the remote device, at step 420. If a Sync Sequence is not periodically received from the remote device, at step 422, the local device will initiate retraining, for example, transitioning back to the Link Training state 304.

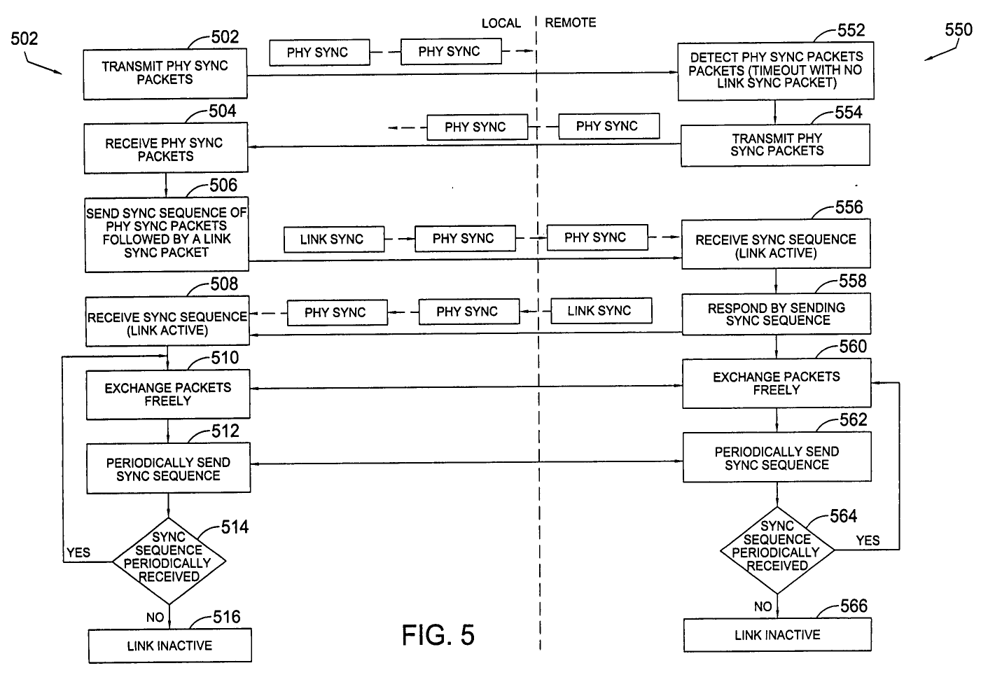

FIG. 5 illustrates link training operations 550 that will be performed on the remote device while corresponding operations 500 are performed on the local device. While FIG. 5 illustratively shows link training being initiated by the local device, it should be understood that either end of the link may actually initiate training independently upon system power up and that which device (e.g., a CPU or GPU) is considered a local device and which is considered a remote device is somewhat arbitrary.

In any case, the operations 500 begin by transmitting Phy-Sync packets from the local device to the remote device. At step 552, the Phy-Sync packets are detected at the remote device, which begins transmitting Phy-Sync packets. Typically, both sides of the link start transmitting Phy-Sync packets when enabled if their state machines indicate that the remote side needs them. At step 504, Phy-Sync packets are received at the local device which, in response, transmits a Sync sequence to the remote device. At step 556, the remote device receives the Sync sequence, causing a transition to the Link Active state. The remote device may respond by sending a Sync Sequence back to the local device, at step 558. At step 508, the local device receives the Sync sequence, causing a transition to the Link Active state. With both devices in the Link Active state, they may exchange packets freely, at steps 510 and 560. As illustrated, to maintain synchronization, each device may periodically send Sync sequences, at steps 512 and 562. If either device fails to receive a Sync sequence within a predetermined period, at steps 514 or 564, that device may transition to the Link Inactive state, at step 516 or 566 (from which link re-training may be initiated).

### CONCLUSION

By performing specially designed operations in hardware, components used to communicate between two or more devices over a communications link may be automatically trained with no software interaction required. Accordingly, the devices may begin link training immediately at power up which may result in availability of the link, fully trained, by the time it is needed by software.

While the foregoing is directed to embodiments of the present invention, other and further embodiments of the invention may be devised without departing from the basic scope thereof, and the scope thereof is determined by the claims that follow.

What is claimed is:

1. A method of training a local device for communication with a remote device over a communications link without software intervention, comprising, under hardware control:
(a) transmitting a plurality of first predefined packets from the local device to the remote device over the communications link;
(b) monitoring the communications link for one or more first predefined data packets transmitted from the remote device to the local device over the communications link;
(c) transmitting a synchronization sequence including a plurality of the first predefined packets followed by a second predefined packet from the local device to the remote device over the communications link, in response to receiving one or more first predefined data packets by the local device from the remote device; and
(d) allowing the exchange of packets under software control only after receiving one or more second predefined packets from the remote device indicating the remote device is trained.

2. The method of claim 1, further comprising periodically transmitting a synchronization sequence from the local device to the remote device over the communications link.

3. The method of claim 2, further comprising repeating steps (a)-(c) by the local device if a synchronization sequence is not received from the remote device within a predetermined timeout period.

4. The method of claim 1, wherein monitoring the communications link for one or more first predefined data packets transmitted from the remote device to the local device over the communications link comprises adjusting for skew between bits of data received over the communication link.

5. The method of claim 4, wherein adjusting for skew between bits of data received over the communication link comprises delaying one or more of the bits relative to other bits and/or a clock signal until a first predefined data packet is detected.

6. The method of claim 5, further comprising asserting a signal to indicate the first predefined data packet has been detected.

7. The method of claim 1, further comprising asserting a signal to indicate the one or more second data packets has been received by the local device from the remote device.

8. A method of training two devices for communication over a link, comprising:
performing initial hardware controlled link training in each device to compensate for skew between bits of data transmitted over the link;
performing hardware controlled handshaking between the devices to indicate successful link training; and
performing periodic hardware controlled link training in each device to periodically adjust for skew between bits of data transmitted over the link.

9. The method of claim 8, wherein performing initial hardware controlled link training in each device comprises, by each device, sending a stream of first predefined data packets to the other device and receiving a stream of first predefined data packets from the other device.

10. The method of claim 8, wherein performing hardware controlled handshaking between the devices to indicate successful link training comprises sending, from each device to the other, a sequence of packets including at least one second predefined data packet.

11. A self-initializing bus interface for use in communicating between a first device containing the bus interface and a second device over a communications link, comprising:
a hardware state machine configured to transmit first predetermined packets to the second device during a link training state and transition to an active state in response to detecting second predetermined packets received from the second device, indicating the second device is trained.

12. The self-initializing bus interface of claim 11, wherein software controlled exchange of data packets is only allowed in the active state.

13. The self-initializing bus interface of claim 11, further comprising:
de-skew circuitry for adjusting the delay of signals received on one or more bit lines of the communications link in response to first predetermined packets received from the second device.

14. The self-initializing bus interface of claim 11, wherein the state machine is further configured to periodically transmit, to the second device, synchronization sequences including one or more first predetermined data packets and at least one second predetermined data packet.

15. The self-initializing bus interface of claim 14, wherein the state machine is further configured to transition back to the link training state if a predetermined period of time passes without receiving a synchronization sequence including one or more first predetermined data packets and at least one second predetermined data packet from the second device.

16. A system, comprising:
a bus having a plurality of parallel bit lines;
a first processing device;
a second processing device coupled with the first processing device via the bus; and
a self-initializing bus interface on each of the first and second processing devices, the bus interface in each device configured to perform, without software interaction, initial link training to compensate for skew between bits of data transmitted over the link, handshaking with the other device to indicate successful link training, and periodic link training to adjust for skew between bits of data transmitted over the bus.

17. The system of claim 16, wherein the bus interface on each device is configured to transmit a stream of first predetermined packets during initial link training.

18. The system of claim 17, wherein the bus interface on each device comprises de-skew circuitry configured to delay a bit signal received on one or more of the bus bit lines until a first predetermined packet is detected.

19. The system of claim 16, wherein the handshaking performed by the bus interface of each device comprises:
indicating the device is trained by sending a second predetermined data packet to the other device; and
receiving a second predetermined data packet from the other device indicating the other device is trained.

20. The system of claim 16, wherein the periodic link training performed by the bus interface of each device comprises:
periodically transmitting, to the other device, a synchronization sequence including a plurality of first predetermined data packets and at least one second data packet.

21. The system of claim 20, wherein the bus interface of each device is further configured to repeat initial link training if a synchronization sequence from the other device is not periodically received.

22. The system of claim 16, wherein the first processing device is a central processing unit (CPU) and the second processing device is a graphics processing unit (GPU).
